(19) United States
(12) Patent Application Publication
(10) Pub. No.: US 2026/0308053 A1
(43) Pub. Date: Oct. 8, 2026

(54) THERMAL COUPLING OF CEMENT PRODUCTION WITH GASIFICATION

(71) Applicant: BASF SE, Ludwigshafen am Rhein (DE)

(72) Inventors: Thomas HORST, Ludwigshafen am Rhein (DE); Paul-Vinzent STROBEL, Ludwigshafen am Rhein (DE); Oliver KOCH, Ludwigshafen am Rhein (DE); Andre BADER, Ludwigshafen am Rhein (DE); Gerrit HARNISCHMACHER, Ludwigshafen am Rhein (DE); Inga VON HARBOU, Ludwigshafen am Rhein (DE); Mohammad Ghith AL SHAAL, Ludwigshafen am Rhein (DE); Simon WACHTER, Ludwigshafen am Rhein (DE)

(21) Appl. No.: 19/475,787

(22) PCT Filed: Apr. 9, 2024
(86) PCT No.: PCT/EP2024/059550

§ 371 Date: Oct. 16, 2025

(30) Foreign Application Priority Data
Apr. 17, 2023 (EP) 23168240.2

(51) Int. Cl. C04B 7/47; C04B 7/44; C10J 1/28

(52) U.S. Cl. CPC C04B 7/475; C04B 7/44; C10J 1/28

(57) ABSTRACT

The present invention concerns a cement plant in which at least a portion of the hot air obtained from a clinker cooler is utilized to provide heat to at least one gasifier. At least a portion of the hot air and the at least one gasifier are directly or indirectly thermally coupled. The invention further relates to a method for gasification of a feedstock in at least one gasifier wherein at least a por-tion of the hot air obtained from a clinker cooler and at least one gasifier is directly or indirectly thermally coupled.

### TECHNICAL AREA

The present invention relates to the thermal coupling of cement production in a cement plant and syngas production in a syngas plant comprising at least one gasifier.

### BACKGROUND OF THE INVENTION

Cement production is among the most energy consuming industrial processes. Accordingly, heat recovery and on-site utilization of the recovered heat is a major necessity in cement production. In modern cement plants, raw clinker is pre-heated in a succession of cyclone-preheaters and fed into a cement kiln, most often a rotary kiln in which the raw clinker is heated up to about 1350° C. to 1500° C. during a residence time of about 20 min to 40 min. Next, the hot clinker leaves the cement kiln and is passing a pre-cooling section at the exit of the cement kiln at a temperature of about 1150° C. to 1350° C. The hot clinker is then fed into a clinker cooler in which it is cooled down to a temperature of about 80° C. to 200° C. by contacting the hot clinker with an air stream in countercurrent or cross/countercurrent flow. The thermal economy of the kiln system is predominantly dependent on the efficiency of the cooling section.

The hot air stream leaving the clinker cooler can be fully utilized as “secondary combustion air” in the cement kiln when using tube coolers, planetary coolers, or satellite coolers. A split-use of hot air is usually not possible in tube coolers, planetary coolers, and satellite coolers. Furthermore, the clinker throughput of tube coolers, planetary coolers, and satellite coolers is limited to about 3000 t/d which renders these types of clinker coolers less attractive for modern cement plants. Grate coolers are suitable for much higher throughputs of more than 10000 t/d hot clinker and a split-use of the hot air obtained in the cooler for later use, which is desirable. Grate coolers require more cooling air than is necessary for later use as e.g., combustion air. One part of the hot air obtained from a grate cooler can be used as a “secondary combustion air” in the cement kiln like in the case of tube coolers, planetary, and satellite coolers. Another part of the hot air can be used as “tertiary combustion air” in case the cement plant is equipped with a calcination chamber as final part of the raw clinker pre-heating unit. A further part of the hot air (“Mittenluft” in German language) and the “tertiary combustion air” in case the cement plant is not equipped with such a calcination chamber is/are either disposed as waste air or used to dry raw materials such as coal and waste used as a primary fuel for the cement kiln or the clinker raw material. The moisture content of such raw materials ranges in average from about 5 wt.-% to about 8 wt.-%. The temperature of the hot air is about 900° C. to 1100° C. (when used as secondary air in proximity of the grate cooler) or about 700° C. to 1000° C. when used as e.g., tertiary combustion air in the more distant optional calcination chamber. The hot air has a temperature of about 250° C. to 350° C. in case the hot air is used to dry raw materials which means that most of the temperature is wasted prior to further use of the hot air. The “Mittenluft” can also be used for steam and/or power generation, however, at a low efficiency of such processes. Accordingly, the utilization of heat generated in clinker coolers in the form of hot air is in cement plants still incomplete even when using modern grate coolers.

Hence, it is the objective of the present invention to provide a cement plant in which the remaining, unused part of the hot air and/or inefficiently used hot air obtained from clinker coolers is utilized in an economic fashion. It is a further objective to provide a method for further utilization of the hot air obtained from clinker coolers in cement plants.

### SUMMARY OF THE INVENTION

The problem of incomplete utilization of hot air obtained from clinker coolers, preferably from grate clinker coolers is solved by a cement plant comprising
(i) at least one cement kiln which is heated by combustion of at least one fuel and in which hot clinker is formed from a pre-heated raw clinker,
(ii) at least one clinker cooler in which said hot clinker transfers heat to an air stream to form a hot air stream,
   wherein said clinker cooler is downstream of and fluidically connected to said at least one cement kiln,
(iii) and at least one gasifier for producing raw syngas from a first feedstock by gasification, said raw syngas optionally comprising halogens,
   wherein at least a portion of said hot air stream formed in step (ii) and said at least one gasifier are directly or indirectly thermally coupled.

The problem of incomplete utilization of hot air obtained from at least one clinker cooler, preferably from at least one grate clinker cooler is further solved by a method for gasification of a first feedstock in at least one gasifier, comprising the steps
(i) providing a cement plant comprising at least one cement kiln, at least one clinker cooler and at least one gasifier,
(ii) forming hot clinker in the at least one cement kiln,
(iii) cooling the hot clinker in at least one clinker cooler with an air stream and thereby forming a hot air stream,
(iv) transferring heat from at least a portion of the hot air stream to the at least one gasifier,
(v) forming raw syngas in the at least one gasifier, said raw syngas optionally comprising halogens.

Preferably in step (iv),
a) at least a portion of the hot air leaving at least one clinker cooler is inserted into at least one gasifier or
b1) thermal energy is transferred from at least a portion of the hot air leaving the at least one clinker cooler to a steam stream and/or an oxygen stream, which steam stream and/or oxygen stream is/are then fed into at least one gasifier or
b2) thermal energy is transferred from at least a portion of the hot air leaving the at least one clinker cooler to a first feedstock, which first feedstock is then fed into at least one gasifier.

Accordingly, in all three cases the at least a portion of the hot air leaving the at least one clinker cooler and the at least one gasifier are directly or indirectly thermally coupled.

Feeding at least a portion of the hot air into the at least one gasifier or feeding a pre-heated oxygen stream and/or steam stream into the at least one gasifier or feeding a pre-heated first feedstock into the at least one gasifier leads to a higher yield of the desired syngas components H₂ and CO formed by the gasification reaction inside the at least one gasifier because less of the first feedstock needs to be completely oxidized to e.g., CO₂ and H₂O to provide the required heat for the gasification reaction.

Both cement plant and method for gasification according to the present invention provide an extended and more efficient utilization of the hot air formed in clinker coolers, preferably in grate clinker coolers, and thereby a more economic and ecologic production of cement.

### FIGURES

FIG. 1 shows a cement plant according to a first embodiment of the present invention.

FIG. 2 shows a cement plant according to a second aspect and a third aspect of a first embodiment of the present invention.

FIG. 3 shows a cement plant according to a second embodiment of the present invention.

FIG. 4 shows a cement plant according to a third embodiment of the present invention.

FIG. 5 shows a cement plant according to a fourth embodiment of the present invention.

### DETAILED DESCRIPTION OF THE INVENTION

The present invention is further described below with reference to the embodiments and figures, but the present invention is not limited to these embodiments, and any modifications or substitutions within the basic spirit of the present invention are still within the scope of the present invention as claimed. Furthermore, the features of the individual embodiments can also be combined to additional embodiments.

### Definitions

In the context of the present description and the accompanying claims, the term “about” preferably means a deviation of the thus described value of +15%.

In the context of the present invention, the term “combinations thereof” is inclusive of one or more of the recited elements.

In the context of the present invention, the term “mixture thereof” is inclusive of one or more of the recited elements.

“Syngas” also known as “synthesis gas” refers to a mixture of predominantly H₂ and CO which can be obtained by gasification of a feedstock in a gasifier.

The term “upstream of” is defined herein in respect to a succession of unit operations as located next to on the side which is against the flow direction of fluids passing said succession of unit operations.

The term “downstream of” is defined herein in respect to a succession of unit operations as located next to on the side which is in the flow direction of fluids passing said succession of unit operations.

The term “fluidically connected to” in respect to two or more units is defined herein that a fluid such as solids, liquids, gases, and mixtures thereof can flow from one of such unit to the other such unit and flow through and/or along such an analytical unit. Two units “fluidically connected to” each other are for example connected by one or more pipes which each other or by screw conveyors or by extruders or by solids pumps.

The term “physically connected to” refers to a direct (“physical”) connection of two or more units (including gasifiers).

The term “thermally coupled” is defined herein as the ability of two material streams; two units; a material stream and a unit; or an assembly of more than two of such list members to transfer heat from one list member to another such list member. For example, a hot material stream a can transfer heat to a cold material stream b in case said material streams a and b are “thermally coupled”, or a hot material stream can transfer heat to a unit such as a gasifier in case said hot material stream and said gasifier are “thermally coupled”.

The term “natural gas pipeline grid” is defined herein as pipelines or a network of pipelines used to transport natural gas and methane, or which are/is suitable for the transport of natural gas and methane. “Natural gas pipeline grids” are also known as “natural gas networks”.

A pre-heated clinker raw mix (1) is entering the at least one cement kiln (2) in which the clinker raw mix (1) is converted by a thermochemical process into hot clinker (3) which leaves the at least one cement kiln in downstream direction. The at least one cement kiln (2) is heated by combustion of at least one fuel together with combustion air.

At least one clinker cooler (4) is downstream of and fluidically connected to the at least one cement kiln (2). The hot clinker (3) is entering the at least one clinker cooler (4) and is contacted with an air stream (6). Next, the cold clinker (5) leaves the at least one clinker cooler (4) in downstream direction and is further processed. Heat is transferred from the hot clinker (3) inside the at least one clinker cooler (4) to the air stream (6) which leaves the at least one clinker cooler (4) as a hot air stream (7).

The pre-heated clinker raw mix (1) has a temperature of about 750° C. to about 850° C. when entering the at least one cement kiln (2). The pre-heated clinker raw mix (1) moves through the at least one cement kiln (2) which is usually a rotary kiln at a temperature of about 1350° C. to about 1500° C. within about 20 min to about 40 min. The hot clinker leaving the at least one cement kiln (2) has a temperature of about 1150° C. to about 1350° C. which is about the same temperature range of the hot clinker (3) when entering the at least one clinker cooler (4).

The clinker cooler (4) is preferably selected from the group comprising tube coolers, planetary coolers, satellite coolers, and grate coolers. Most preferably, the clinker cooler (4) is a grate cooler.

In case the clinker cooler (4) is a grate cooler, hot clinker is transported through the cooler horizontally and an air stream (6) is either blown from the bottom area of the at least one clinker cooler (4) through the hot clinker (3) and leaves the at least one clinker cooler (4) on the top section as a hot air stream (7) (=cross-countercurrent flow) or the air stream (6) is directed in a countercurrent flow scheme towards the moving hot clinker (3). The temperature of the hot air stream (7) preferably ranges from about 700° C. to about 1100° C.

Next, at least a portion of the hot air stream (7) is used to provide heat for a gasification reaction in at least one gasifier (8). Accordingly, at least a portion of the hot air stream (7) is thermally coupled with the at least one gasifier (8). A first feedstock (9) enters the at least one gasifier (8) in which said first feedstock (9) is converted by a gasification reaction into raw syngas (10) which leaves the at least one gasifier (8) in downstream direction. The raw syngas (10) optionally comprises halogens.

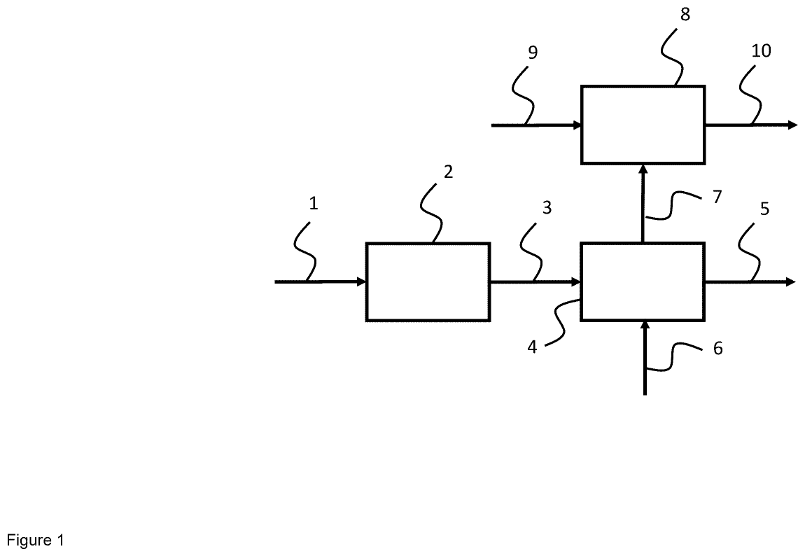

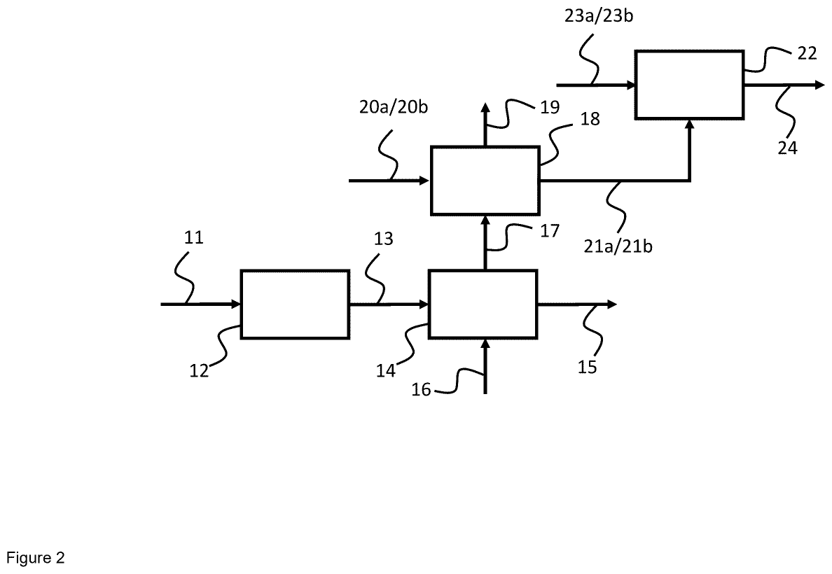

The type of thermal coupling of at least a portion of the hot air stream and the at least one gasifier (8) depends on the type of gasifier(s) used in the cement plant and the method according to the present invention:
a) in a first aspect of the first embodiment (FIG. 1), at least a portion of the hot air stream (7) is inserted into the at least one gasifier (8) in case the at least one gasifier (8) is selected from the group consisting of counter-current fixed bed reactors, co-current-fixed bed reactors, bubbling fluidized bed reactors, and circulation fluidized bed reactors and wherein at least a portion of the hot air stream is inserted into said gasifier. In this case at least a portion of the hot air stream (7) transfers heat to the at least one gasifier (8), i.e., is directly thermally coupled with the at least one gasifier (8) and in addition serves as an oxidant in the gasification reaction (which is a partial oxidation reaction which requires at least one oxidant) or
b1) in a second aspect of the first embodiment (FIG. 2), the heat is preferably transferred from at least a portion of the hot air stream (17) to the at least one gasifier (22) in case the at least one gasifier is selected from the group consisting of downdraft entrained flow reactors and updraft entrained flow reactors by transferring heat from at least a portion of the hot air stream (17) in at least one means for heat transfer (18) to a steam stream (20a) and/or to an oxygen stream (20a) to form a pre-heated steam stream (21a) and/or a hot oxygen stream (21a) which is/are then fed into the at least one gasifier (22) as an oxidant, and wherein at least a portion of the hot air stream (17) and the at least one gasifier (22) are indirectly thermally coupled by the steam stream (20a) and/or the oxygen stream (20a) or
b2) in a third aspect of the first embodiment (FIG. 2), the heat is transferred from at least a portion of the hot air stream (17) to the at least one gasifier (22) by a means for heat transfer (18) in case the at least one gasifier (22) is selected from the group consisting of downdraft entrained flow reactors and updraft entrained flow reactors wherein heat from at least a portion of the hot air stream (17) is transferred in a means for heat transfer (18) to the first feedstock stream (20b) to form a pre-heated first feedstock stream (21b) which is then fed into the at least one gasifier (22), and wherein at least a portion of the hot air stream (17) and the at least one gasifier (22) are indirectly thermally coupled by the first feedstock stream (20b).

The second aspect b1) of the first embodiment and the third aspect b2) of the first embodiment are shown in FIG. 2.

In the first aspect, at least a portion of the hot air stream (7) is inserted into the at least one gasifier (8) in case the at least one gasifier (8) is selected from the group consisting of countercurrent fixed bed reactors, co-current-fixed bed reactors, bubbling fluidized bed reactors, and circulation fluidized bed reactors for example with at least one burner. Other suitable means for inserting a hot air stream into such gasifiers are known in the art and can be selected accordingly.

In the second aspect of the first embodiment of the present invention (FIG. 2), the clinker raw mix (11) enters the at least one cement kiln (12) and the hot clinker (13) leaves the at least one cement kiln (12) in downstream direction. Next, the hot clinker (13) enters the clinker cooler (14) which is downstream of and fluidically connected to the at least one cement kiln (12). The hot clinker (13) is cooled by an air stream (16) in the clinker cooler (14). The cold clinker (15) leaves the clinker cooler (14) in downstream direction. At least a portion of the hot air stream (17) also leaves the clinker cooler (14) and is inserted into at least one means for heat transfer (18) which is fluidically connected to the clinker cooler (14). A steam stream (20a) and/or an oxygen stream (20a) also enters the at least one means for heat transfer (18). Heat is transferred from at least a portion of the hot air stream (17) to the steam stream (20a) and/or to the oxygen stream (20a) inside the at least one means for heat transfer (18). A cold air stream (19) and a pre-heated steam stream (21a) and/or hot oxygen stream (21a) leave the at least one means for heat transfer (18) through a cold air stream (19) outlet and a pre-heated steam (21a) outlet and/or a hot oxygen stream (21a) outlet, respectively. The pre-heated steam (21a) and/or the hot oxygen stream (21a) then enter(s) the at least one gasifier (22) which is downstream of and fluidically connected to the pre-heated steam (21a) outlet and/or the hot oxygen stream (21a) outlet. The pre-heated steam stream (21a) and/or the hot oxygen stream (21a) serve(s) as the oxidant for the gasification reaction inside the at least one gasifier (22). A first feedstock stream (23a) enters the at least one gasifier (22) and is converted in a gasification reaction with the pre-heated steam stream and/or the hot oxygen stream (21a) to a raw syngas stream (24) which leaves the at least one gasifier (22) in downstream direction. The raw syngas stream (24) optionally comprises halogens.

Preferably, a steam stream (20a) is heated in the at least one means for heat transfer by at least a portion of the hot air stream (17) before entering the at least one gasifier (22) as a preheated steam stream (21a). More preferably, an oxygen stream (20a) is heated in the at least one means by heat transfer by at least a portion of the hot air stream (17) before entering the at least one gasifier (22) as a hot oxygen stream (21a). Most preferably, heat is transferred from at least a portion of the hot air stream in a first means for heat transfer to the steam stream and then heat is transferred from at least a portion of the hot air stream in a second means for heat transfer to the oxygen stream.

The at least one gasifier (22) is preferably selected in this second aspect of the first embodiment from the group consisting of downdraft entrained flow reactors and updraft entrained flow reactors.

The at least one means for heat transfer (18) in the second aspect of the first embodiment is preferably a heat exchanger suitable for transferring heat from a first gaseous stream to a second gaseous stream. The means for heat transfer (18) is more preferably selected from the group comprising double-pipe heat exchangers, shell-and-tube heat exchangers, plate heat exchangers, plate fin heat exchangers, microchannel heat exchangers, and waste heat recovery units. Suitable flow arrangements comprise counter-current flow, cross-current flow and the like.

In case heat is transferred from at least a portion of the hot air stream to the oxygen stream and the steam stream, heat is preferably transferred from at least a portion of the hot air stream to the steam stream in a first means for heat transfer and then heat is transferred from at least a portion of the hot air stream to the oxygen stream in a second means for heat transfer. More preferably, the first means for heat transfer is a heat exchanger suitable for transferring heat from a first gaseous stream to a second gaseous stream and the second means for heat transfer is a heat exchanger suitable for transferring heat from a first gaseous stream to a second gaseous stream. Most preferably, the first means for heat transfer is selected from the group comprising double-pipe heat exchangers, shell-and-tube heat exchangers, plate heat exchangers, plate fin heat exchangers, microchannel heat exchangers, and waste heat recovery units. Most preferably, the second means for heat transfer is selected from the group comprising double-pipe heat exchangers, shell-and-tube heat exchangers, plate heat exchangers, plate fin heat exchangers, microchannel heat exchangers, and waste heat recovery units. Suitable flow arrangements comprise for the first means for heat transfer and the second means for heat transfer counter-current flow, cross-current flow and the like.

In the third aspect of the first embodiment of the present invention (FIG. 2), the clinker raw mix (11) enters the at least one cement kiln (12) and the hot clinker (13) leaves the at least one cement kiln (12) in downstream direction. Next, the hot clinker (13) enters the clinker cooler (14) which is downstream of and fluidically connected to the at least one cement kiln (12). The hot clinker (13) is cooled by an air stream (16) in the clinker cooler (14). The cold clinker (15) leaves the clinker cooler (14) in downstream direction. At least a portion of the hot air stream (17) also leaves the clinker cooler (14) and is inserted into a means for heat transfer (18) which is fluidically connected to the clinker cooler (14). A first feedstock stream (20b) also enters the means for heat transfer (18). Heat is transferred from at least a portion of the hot air stream (17) to the first feedstock stream (20b) inside the means for heat transfer (18). A cold air stream (19) and a pre-heated first feedstock stream (21b) leave the means for heat transfer (18) through a cold air stream (19) outlet and a pre-heated first feedstock stream (21b) outlet, respectively. The preheated first feedstock stream (21b) then enters the at least one gasifier (22) which is downstream of and fluidically connected to the pre-heated first feedstock stream (21b) outlet. The pre-heated first feedstock stream (21b) enters the at least one gasifier (22) and is converted in a gasification reaction with an oxygen stream (23b) which is also fed into the at least one gasifier (22) and which serves as the oxidant, to a raw syngas stream (24) which leaves the at least one gasifier (22) in downstream direction. The raw syngas stream (24) optionally comprises halogens.

The at least one gasifier (22) is preferably selected in this third aspect of the first embodiment from the group consisting of downdraft entrained flow reactors and updraft entrained flow reactors.

The means for heat transfer (18) is preferably a heat exchanger suitable for transferring heat from a gaseous stream (at least a portion of the hot air stream (17)) to a solid and/or liquid first feedstock stream (20b). Suitable heat exchangers comprise direct contact heat exchangers, plate heat exchangers, tube heat exchangers and the like. Suitable heat exchangers for transferring heat from a gaseous stream (at least a portion of the hot air stream (17)) to a solid and/or liquid first feedstock (20b) are known in the art and can be selected accordingly. Suitable flow arrangements comprise counter-current flow, cross-current flow and the like.

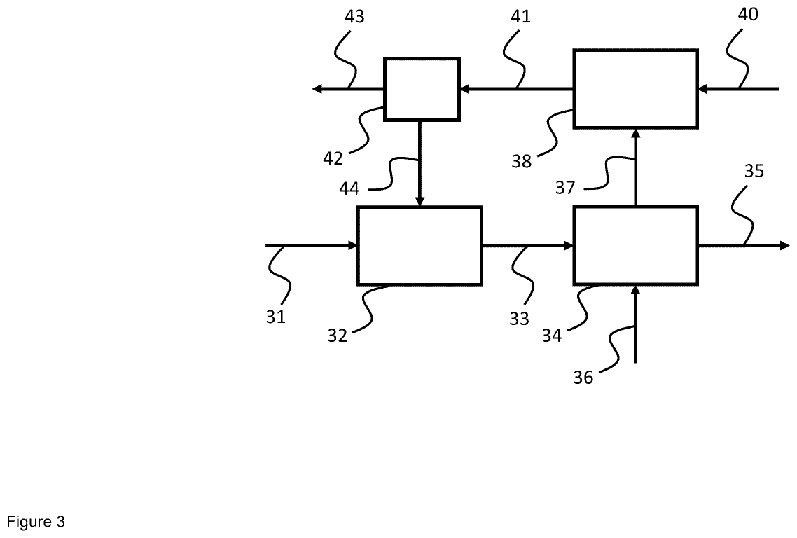

In a second embodiment of the present invention (FIG. 3), the cement plant comprises at least one cement kiln, at least one clinker cooler, and at least one gasifier.

A pre-heated clinker raw mix (31) is entering the at least one cement kiln (32) in which the clinker raw mix (31) is converted by a thermochemical process into hot clinker (33) which leaves the at least one cement kiln (32) in downstream direction. The at least one cement kiln (32) is heated by combustion of at least one fuel.

At least one clinker cooler (34) is downstream of and fluidically connected to the at least one cement kiln (32). The hot clinker (33) is entering the at least one clinker cooler (34) and is contacted with an air stream (36). Next, the cold clinker (35) leaves the at least one clinker cooler (34) in downstream direction and is further processed. Heat is transferred from the hot clinker (33) inside the at least one clinker cooler (34) to the air stream (36) which leaves the at least one clinker cooler (34) as a hot air stream (37).

The pre-heated clinker raw mix (31) has a temperature of about 750° C. to about 850° C. when entering the at least one cement kiln (32). The pre-heated clinker raw mix (31) moves through the at least one cement kiln (32) which is usually a rotary kiln at a temperature of about 1350° C. to about 1500° C. within about 20 min to about 40 min. The hot clinker leaving the at least one cement kiln (32) has a temperature of about 1150° C. to about 1350° C. which is about the same temperature range of the hot clinker (33) when entering the at least one clinker cooler (34).

The clinker cooler (34) is preferably a grate cooler through which the hot clinker is transported horizontally, and an air stream (36) is blown from the bottom area of the at least one clinker cooler (34) through the hot clinker (33) (=cross-countercurrent flow) or the air stream (36) is directed in a countercurrent flow scheme towards the moving hot clinker (33) and leaves the at least one clinker cooler (34) on the top section as a hot air stream (37). The temperature of the hot air stream (37) preferably ranges from about 700° C. to about 1100° C.

Next, at least a portion of the hot air stream (37) is used to provide heat for a gasification reaction in at least one gasifier (38). Accordingly, at least a portion of the hot air stream (37) is thermally coupled with the at least one gasifier (38). A first feedstock (40) enters the at least one gasifier (38) in which said first feedstock (40) is converted by a gasification reaction into raw syngas (41) which leaves the at least one gasifier (38) in downstream direction.

A first portion of the raw syngas stream (43) is then separated from the raw syngas stream (41) in an optional syngas stream splitter (42). The first portion of the raw syngas stream (43) can be used for example as a feedstock for the (petro-) chemical industry and production of e.g., methane, methanol, and Fischer-Tropsch hydrocarbons.

A second portion of the raw syngas stream (44) is also separated from the raw syngas stream (41) in the optional syngas stream splitter (42). The second raw syngas stream (44) is then used as a complemental fuel for the at least one cement kiln (32). Accordingly, at least a portion of the raw syngas (44) formed in the at least one gasifier (38) is used as a fuel to heat the at least one cement kiln (32) by combustion of said fuel.

The type of thermal coupling of at least a portion of the hot air stream and the at least one gasifier depends on the type of gasifier(s) used in the cement plant according to the present invention:
a) at least a portion of the hot air stream (37) is inserted into the at least one gasifier (38) in case the at least one gasifier (38) is selected from the group consisting of counter-current fixed bed reactors, co-current-fixed bed reactors, bubbling fluidized bed reactors, and circulation fluidized bed reactors and wherein at least a portion of the hot air stream is inserted into said gasifier. In this case the at least a portion of the hot air stream (37) transfers heat to the at least one gasifier (38), i.e., is directly thermally coupled with the at least one gasifier (38) and in addition serves as the oxidant (which is a partial oxidation reaction which requires at least one oxidant) or
b1) the heat is preferably transferred from at least a portion of the hot air stream (37) to the gasifier (second aspect of the second embodiment, not shown in FIG. 3) in case the at least one gasifier is selected from the group consisting of downdraft entrained flow reactors and updraft entrained flow reactors by transferring heat from at least a portion of the hot air stream (37) in at least one means for heat transfer to a steam stream and/or an oxygen stream to form a pre-heated steam stream and/or a hot oxygen stream, wherein the preheated steam stream and/or the hot oxygen stream is then fed into the at least one gasifier and serves as the oxidant and wherein at least a portion of the hot air stream and the at least one gasifier are indirectly thermally coupled by the steam stream and/or the oxygen stream or
b2) heat is transferred from at least a portion of the hot air stream (37) to the at least one gasifier by a means for heat transfer (third aspect of the second embodiment, not shown in FIG. 3) in case the at least one gasifier is selected from the group consisting of downdraft entrained flow reactors and updraft entrained flow reactors wherein heat from at least a portion of the hot air stream is transferred by a means for heat transfer to a first feedstock stream to form a pre-heated first feedstock stream which is then fed into the at least one gasifier and wherein at least a portion of the hot air stream and the at least one gasifier are indirectly thermally coupled by the first feedstock stream.

At least a portion of the hot air stream (37) can be inserted into the at least one gasifier (38) in case the at least one gasifier (38) is selected from the group consisting of counter-current fixed bed reactors, co-current-fixed bed reactors, bubbling fluidized bed reactors, and circulation fluidized bed reactors for example with at least one burner. Other suitable means for inserting a hot air stream into such gasifiers are known in the art and can be selected accordingly.

In the second aspect of the second embodiment of the present invention, the clinker raw mix (31) enters the at least one cement kiln (32) and the hot clinker (33) leaves the at least one cement kiln (32) in downstream direction. Next, the hot clinker (33) enters the clinker cooler (34) which is downstream of and fluidically connected to the at least one cement kiln (32). The hot clinker (33) is cooled by an air stream (36) in the clinker cooler (34). The cold clinker (35) leaves the clinker cooler (34) in downstream direction. The hot air stream (37) also leaves the clinker cooler (34) and is inserted into at least one means for heat transfer (not shown in FIG. 3) which is fluidically connected to the clinker cooler (34). A steam stream and/or an oxygen stream (not shown in FIG. 3) also enter(s) the at least one means for heat transfer. Heat is transferred from at least a portion of the hot air stream (37) to the steam stream and/or oxygen stream inside the at least one means for heat transfer. A cold air stream (not shown in FIG. 3) and a pre-heated steam stream and/or a hot oxygen stream (not shown in FIG. 3) leave the at least one means for heat transfer through a cold air stream outlet and a pre-heated steam stream outlet and/or a hot oxygen stream outlet, respectively. The pre-heated air stream and/or the hot oxygen stream then enter(s) the at least one gasifier (38) which is downstream of and fluidically connected to the pre-heated steam stream outlet and/or hot oxygen stream outlet. The pre-treated steam stream and/or the hot oxygen stream serves as the oxidant for the gasification reaction inside the at least one gasifier (38). A first feedstock stream (40) enters the at least one gasifier (38) and is converted in a gasification reaction with the pre-heated steam stream and/or the hot oxygen stream to a raw syngas stream (41) which leaves the at least one gasifier (38) in downstream direction. The raw syngas stream (41) optionally comprises halogens.

The at least one gasifier (38) is preferably selected in this second aspect of the second embodiment from the group consisting of downdraft entrained flow reactors and updraft entrained flow reactors.

Preferably, the steam stream is heated in the at least one means for heat transfer by at least a portion of the hot air stream (37) before entering the at least one gasifier (38) as a pre-heated steam stream. More preferably, the oxygen stream is heated in the at least one means by heat transfer by at least a portion of the hot air stream (37) before entering the at least one gasifier (38) as a hot oxygen stream. Most preferably, heat is transferred from at least a portion of the hot air stream in a first means for heat transfer to a steam stream and then heat is transferred in a second means for heat transfer from at least a portion of hot air stream to an oxygen stream.

The at least one means for heat transfer is preferably a heat exchanger suitable for transferring heat from a first gaseous stream to a second gaseous stream. The means for heat transfer (18) is more preferably selected from the group comprising double-pipe heat exchangers, shell-and-tube heat exchangers, plate heat exchangers, plate fin heat exchangers, microchannel heat exchangers, and waste heat recovery units. Suitable flow arrangements comprise countercurrent flow, cross-current flow and the like.

In case heat is transferred from at least a portion of the hot air stream to the oxygen stream and the steam stream, heat is preferably transferred from at least a portion of the hot air stream to the steam stream in a first means for heat exchange and then heat is transferred from at least a portion of the hot air stream to the oxygen stream in a second means for heat transfer. More preferably, the first means for heat transfer is a heat exchanger suitable for transferring heat from a first gaseous stream to a second gaseous stream and the second means for heat transfer is a heat exchanger suitable for transferring heat from a first gaseous stream to a second gaseous stream. Most preferably, the first means for heat transfer is selected from the group comprising double-pipe heat exchangers, shell-and-tube heat exchangers, plate heat exchangers, plate fin heat exchangers, microchannel heat exchangers, and waste heat recovery units. Most preferably, the second means for heat transfer is selected from the group comprising double-pipe heat exchangers, shell-and-tube heat exchangers, plate heat exchangers, plate fin heat exchangers, microchannel heat exchangers, and waste heat recovery units. Suitable flow arrangements comprise for the first means for heat transfer and the second means for heat transfer counter-current flow, cross-current flow and the like.

In the third aspect of the second embodiment of the present invention, the clinker raw mix (31) enters the at least one cement kiln (32) and the hot clinker (33) leaves the at least one cement kiln (32) in downstream direction. Next, the hot clinker (33) enters the clinker cooler (34) which is downstream of and fluidically connected to the at least one cement kiln (32). The hot clinker (33) is cooled by an air stream (36) in the clinker cooler (34). The cold clinker (35) leaves the clinker cooler (34) in downstream direction. At least a portion of the hot air stream (37) also leaves the clinker cooler (34) and is inserted into a means for heat transfer (not shown in FIG. 3) which is fluidically connected to the clinker cooler (34). A first feedstock stream (not shown in FIG. 3) also enters the means for heat transfer. Heat is transferred from at least a portion of the hot air stream (37) to the first feedstock stream inside the means for heat transfer. A cold air stream and a pre-heated first feedstock stream (not shown in FIG. 3) leave the means for heat transfer through a cold air stream outlet and a pre-heated first feedstock stream outlet, respectively. The pre-heated first feedstock stream is then fed into the at least one gasifier (38) which is downstream of and fluidically connected to the pre-heated first feedstock stream outlet and is converted in a gasification reaction with an oxygen stream (as oxidant for the gasification reaction) to a raw syngas stream (41) which leaves the at least one gasifier (38) in downstream direction.

The at least one gasifier (38) is preferably selected in this third aspect of the second embodiment from the group consisting of downdraft entrained flow reactors and updraft entrained flow reactors.

The means for heat transfer is preferably a heat exchanger suitable for transferring heat from a gaseous stream (at least a portion of the hot air stream (37)) to a solid and/or liquid feedstock stream. Suitable heat exchangers comprise direct contact heat exchangers, plate heat exchangers, tube heat exchangers and the like. Suitable heat exchangers for transferring heat from a gaseous stream (at least a portion of the hot air stream (37)) to a solid and/or liquid feedstock are known in the art and can be selected accordingly. Suitable flow arrangements comprise counter-current flow, cross-current flow and the like.

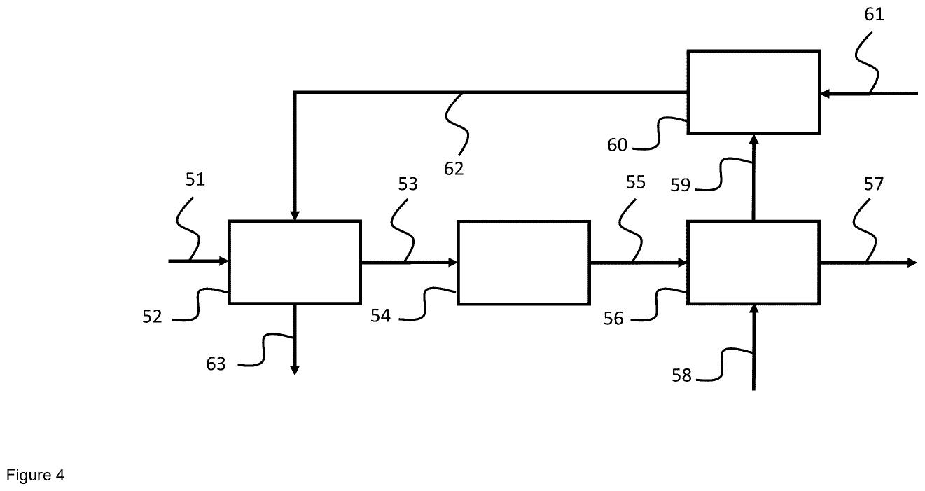

In a third embodiment of the present invention (FIG. 4), the cement plant comprises at least one cement kiln, at least one clinker cooler, at least one gasifier, and at least one dehalogenation unit.

A pre-heated clinker raw mix (51) is entering the at least one dehalogenation unit (52) and leaving said at least one dehalogenation unit (52) in downstream direction as a stream of halogen loaded clinker (53). The dehalogenation unit (52) is downstream of and fluidically connected to the pre-heating unit (not shown in FIG. 4) for the raw clinker. The pre-heated clinker raw mix (51) has a temperature of about 800° C. to about 850° C. when leaving the pre-heating unit and entering the dehalogenation unit (52). The pre-heating unit is preferably a multi-staged cyclone system such as a four-, five- or six-staged cyclone preheater.

The stream of halogen loaded clinker (53) is then either entering the at least one cement kiln (54) in which the stream of halogen loaded clinker (53) is converted by a thermochemical process into hot clinker (55) which leaves the at least one cement kiln (54) in downstream direction or first entering an optional calcinatory (calcination unit) and then the at least one cement kiln (54). The at least one cement kiln (54) is either downstream of and fluidically connected to the at least one dehalogenation unit (52) or downstream of and fluidically connected to the optional calcinatory and is in both cases preferably heated by combustion of at least one fuel.

At least one clinker cooler (56) is downstream of and fluidically connected to the at least one cement kiln (54). The hot clinker (55) is entering the at least one clinker cooler (56) and is contacted with an air stream (58). Next, the cold clinker (57) leaves the at least one clinker cooler (56) in downstream direction and is further processed. Heat is transferred from the hot clinker (55) inside the at least one clinker cooler (56) to the air stream (58) which leaves the at least one clinker cooler (56) as a hot air stream (59).

The halogen loaded clinker (53) has a temperature of about 700° C. to about 900° C. when entering the at least one cement kiln (54). The halogen loaded clinker (53) moves through the at least one cement kiln (54) which is usually a rotary kiln at a temperature of about 1350° C. to about 1500° C. within about 20 min to about 40 min. The hot clinker (57) leaving the at least one cement kiln (54) has a temperature of about 1150° C. to about 1350° C. which is about the same temperature range of the hot clinker (55) when entering the at least one clinker cooler (57).

The clinker cooler (56) is preferably a grate cooler through which the hot clinker is transported horizontally, and an air stream (58) is blown from the bottom area of the at least one clinker cooler (56) through the hot clinker (55) (=cross-countercurrent flow) or the air stream (58) is directed in a countercurrent flow scheme towards the moving hot clinker (55). The temperature of the hot air stream (59) ranges from about 700° C. to about 1100° C.

Next, at least a portion of the hot air stream (59) is used to provide heat for a gasification reaction in at least one gasifier (60). Accordingly, at least a portion of the hot air stream (59) is thermally coupled with the at least one gasifier (60). A first feedstock (61) enters the at least one gasifier (60) in which said first feedstock 61) is converted by a gasification reaction into raw syngas (62), said raw syngas (62) comprising halogens, which leaves the at least one gasifier (60) in downstream direction.

The raw syngas (62) is then inserted into the dehalogenation unit (52) in which it is contacted with the pre-heated clinker raw mix (51). The dehalogenation unit (52) can be for example a means for conveying the pre-heated clinker raw mix (51) and the raw syngas (62) is contacted meanwhile with the pre-heated clinker raw mix (51). The dehalogenation unit (52) can also be a cyclone such as (one of) the cyclones used for pre-heating the clinker raw mix or an additional cyclone. The pre-heated clinker raw mix (51) is contacted in such a cyclone with the raw syngas (62) and at least a portion of the halogens in the raw syngas (62) are transferred thereby to the pre-heated clinker raw mix (51). The raw syngas (62) comprises halogen-containing compounds (“halogens”) as impurities which for example, react with alkali metal (ions) present on the surface and inside the pre-heated clinker raw mix (51) and thereby form alkali metal halogenides in the at least one dehalogenation unit (52). Thereby, the raw syngas (62) is converted into a at least partially dehalogenated syngas (63). The pre-heated clinker raw mix (51) serves as a moving bed inside the at least one dehalogenation unit (52). The pre-heated clinker raw mix (51) and the raw syngas (62) can be contacted inside the at least one dehalogenation unit (52) in the same direction (co-current flow), cross-countercurrent, or in opposite directions (countercurrent flow). Preferably, the clinker raw mix (51) and the raw syngas (62) are contacted in a countercurrent flow.

Accordingly, the cement plant further comprises a means for pre-heating the raw clinker mix and a means for contacting said pre-heated raw clinker mix with said raw syngas comprising halogens whereby at least a portion of said halogens are transferred from said raw syngas to said pre-treated clinker and wherein said means for contacting said pre-heated raw clinker mix with said raw syngas comprising halogens has an entrance and an exit for pre-heated raw clinker mix and wherein said entrance for pre-heated raw clinker mix is downstream of and fluidically connected to said means for pre-heating the raw clinker mix and wherein said at least one cement kiln is downstream of and fluidically connected to said exit for pre-heated raw clinker mix.

The halogen component of the halogen-containing compounds is converted, for example, to alkali-halogenides such as NaCl and KCl which are then decomposed in the at least one cement kiln (54). The halogens are removed from the at least one cement kiln (54) as part of the burnt fuel exhaust stream and re-entered as hot gas into the pre-heating unit. Hence, the halogenides transferred from the raw syngas (62) to the pre-heated clinker raw mix (53) become part of the “inner halogenide cycle” of the cement plant.

The type of thermal coupling of at least a portion of the hot air stream and the at least one gasifier depends on the type of gasifier used in the cement plant according to the present invention:
a) at least a portion of the hot air stream (59) can be inserted into the at least one gasifier (60) in case the at least one gasifier (60) is selected from the group consisting of counter-current fixed bed reactors, co-current-fixed bed reactors, bubbling fluidized bed reactors, and circulation fluidized bed reactors and wherein at least a portion of the hot air stream is inserted into said gasifier. In this case at least a portion of the hot air stream (59) transfers heat to the at least one gasifier (60), i.e., is directly thermally coupled with the at least one gasifier (60) and in addition serves as the oxidant (which is a partial oxidation reaction which requires at least one oxidant) or
b1) the heat is transferred from at least a portion of the hot air stream (59) to the at least one gasifier (60) (second aspect of the third embodiment, not shown in FIG. 4) in case the at least one gasifier (60) is selected from the group consisting of downdraft entrained flow reactors and updraft entrained flow reactors by transferring heat from at least a portion of the hot air stream in at least one means for heat transfer to a steam stream and/or an oxygen stream to form a pre-heated steam stream and/or a hot oxygen stream which is then fed into the at least one gasifier and serves as the oxidant and wherein at least a portion of the hot air stream and the at least one gasifier are indirectly thermally coupled by the steam stream and/or the hot oxygen stream or
b2) heat is transferred from at least a portion of the hot air stream (59) to the at least one gasifier (third aspect of the third embodiment, not shown in FIG. 4) in case the at least one gasifier is selected from the group consisting of downdraft entrained flow reactors and updraft entrained flow reactors by transferring heat from at least a portion of the hot air stream in a means for heat transfer to a first feedstock stream to form a pre-heated first feedstock stream and wherein at least a portion of the hot air stream and the at least one gasifier are indirectly thermally coupled by the first feedstock stream.

At least a portion of the hot air stream (59) can be inserted into the at least one gasifier (60) in case the at least one gasifier (60) is selected from the group consisting of counter-current fixed bed reactors, co-current-fixed bed reactors, bubbling fluidized bed reactors, and circulation fluidized bed reactors for example with at least one burner. Other suitable means for inserting at least a portion of the hot air stream into such gasifiers are known in the art and can be selected accordingly.

In the second aspect and the third aspect of the third embodiment of the present invention, the pre-heated clinker raw mix (51) is entering the at least one dehalogenation unit (52) and leaving said at least one dehalogenation unit (52) in downstream direction as a stream of halogen loaded clinker (53). The stream of halogen loaded clinker (53) is then entering the at least one cement kiln (54) in which the stream of halogen loaded clinker (53) is converted by a thermochemical process into hot clinker (55) which leaves the at least one cement kiln (54) in downstream direction. The at least one cement kiln (54) is downstream of and fluidically connected to the at least one dehalogenation unit (52) and is heated by combustion of at least one fuel.

In the second aspect of the third embodiment, at least a portion of the hot air stream (59) leaves the clinker cooler (56) and is inserted into at least one means for heat transfer (not shown in FIG. 4) which is fluidically connected to the clinker cooler (56). A steam stream and/or an oxygen stream also enter(s) the means for heat transfer. Heat is transferred from at least a portion of the hot air stream (59) to the steam stream and/or the oxygen stream inside the at least one means for heat transfer. A cold air stream and a pre-heated steam stream and/or the hot oxygen stream leave the at least one means for heat transfer through a cold air stream outlet and a pre-heated steam stream outlet and/or a hot oxygen stream outlet, respectively. The pre-heated steam stream and/or the hot oxygen stream then enter(s) the at least one gasifier (60) which is downstream of and fluidically connected to the pre-heated steam stream outlet and/or the hot oxygen stream outlet. The pre-heated steam stream and/or the hot oxygen stream serve(s) as the oxidant for the gasification reaction inside the at least one gasifier (60). A first feedstock stream (61) enters the at least one gasifier (60) and is converted in a gasification reaction with the pre-heated steam stream and/or the hot oxygen stream to a raw syngas stream (62) which leaves the at least one gasifier (60) in downstream direction.

The at least one gasifier (60) is preferably selected in this second aspect of the second embodiment from the group consisting of downdraft entrained flow reactors and updraft entrained flow reactors.

Preferably, the steam stream is heated in the at least one means for heat transfer by at least a portion of the hot air stream (59) before entering the at least one gasifier (60) as a pre-heated steam stream. More preferably, the oxygen stream is heated in the at least one means by heat transfer by at least a portion of the hot air stream (59) before entering the at least one gasifier (60) as a hot oxygen stream. Most preferably, heat is transferred from at least a portion of the hot air stream in a first means for heat transfer to a steam stream and then heat is transferred from at least a portion of the hot air stream in a second means for heat transfer to the oxygen stream.

The at least one means for heat transfer is preferably a heat exchanger suitable for transferring heat from a first gaseous stream to a second gaseous stream. The means for heat transfer (18) is more preferably selected from the group comprising double-pipe heat exchangers, shell-and-tube heat exchangers, plate heat exchangers, plate fin heat exchangers, microchannel heat exchangers, and waste heat recovery units. Suitable flow arrangements comprise countercurrent flow, cross-current flow and the like.

In case heat is transferred from at least a portion of the hot air stream to the oxygen stream and the steam stream, heat is preferably transferred from at least a portion of the hot air stream to the steam stream in a first means for heat exchange and then heat is transferred from at least a portion of the hot air stream to the oxygen stream in a second means for heat transfer. More preferably, the first means for heat transfer is a heat exchanger suitable for transferring heat from a first gaseous stream to a second gaseous stream and the second means for heat transfer is a heat exchanger suitable for transferring heat from a first gaseous stream to a second gaseous stream. Most preferably, the first means for heat transfer is selected from the group comprising double-pipe heat exchangers, shell-and-tube heat exchangers, plate heat exchangers, plate fin heat exchangers, microchannel heat exchangers, and waste heat recovery units. Most preferably, the second means for heat transfer is selected from the group comprising double-pipe heat exchangers, shell-and-tube heat exchangers, plate heat exchangers, plate fin heat exchangers, microchannel heat exchangers, and waste heat recovery units. Suitable flow arrangements comprise for the first means for heat transfer and the second means for heat transfer counter-current flow, cross-current flow and the like.

In the third aspect of the third embodiment of the present invention, at least a portion of the hot air stream (59) leaves the clinker cooler (56) and is inserted into a means for heat transfer (not shown in FIG. 4) which is fluidically connected to the clinker cooler (56). A first feedstock stream (not shown in FIG. 4) also enters the means for heat transfer. Heat is transferred from at least a portion of the hot air stream (59) to the first feedstock stream inside the means for heat transfer. A cold air stream and a pre-heated first feedstock stream leave the means for heat transfer through a cold air stream outlet and a pre-heated first feedstock stream outlet, respectively. The pre-heated first feedstock stream is then fed into the at least one gasifier (60) which is downstream of and fluidically connected to the pre-heated first feedstock stream outlet of the means for heat transfer and is converted in a gasification reaction with an oxygen stream also fed into the at least one gasifier to a raw syngas stream (62) which leaves the at least one gasifier (60) in downstream direction.

The at least one gasifier (60) is preferably selected in this third aspect of the third embodiment from the group consisting of downdraft entrained flow reactors and updraft entrained flow reactors.

The means for heat transfer is preferably a heat exchanger suitable for transferring heat from a gaseous stream (at least a portion of the hot air stream (59)) to a solid and/or liquid first feedstock stream. Suitable heat exchangers comprise direct contact heat exchangers, plate heat exchangers, tube heat exchangers and the like. Suitable heat exchangers for transferring heat from a gaseous stream (at least a portion of the hot air stream (59)) to a solid and/or liquid first feedstock are known in the art and can be selected accordingly. Suitable flow arrangements comprise counter-current flow, cross-current flow and the like.

The halogen loaded clinker (53) has a temperature of about 700° C. to about 900° C. when entering the at least one cement kiln (54). The halogen loaded clinker (53) moves through the at least one cement kiln (54) which is usually a rotary kiln at a temperature of about 1350° C. to about 1500° C. within about 20 min to about 40 min. The hot clinker (55) leaving the at least one cement kiln (54) has a temperature of about 1150° C. to about 1350° C. which is about the same temperature range of the hot clinker (55) when entering the at least one clinker cooler (56).

The raw syngas (62) is then inserted into the dehalogenation unit (52) in which it is contacted with the clinker raw mix (51). The raw syngas (62) comprises halogen-containing compounds (“halogens”) as impurities which react with alkali metal (ions) present on the surface and in the of the pre-heated clinker raw mix and form alkali metal halogenides in the at least one dehalogenation unit (52). Thereby, the raw syngas (62) is converted into an at least partially dehalogenated syngas (63). The clinker raw mix (51) serves as a moving bed inside the at least one dehalogenation unit (52). The clinker raw mix (51) and the raw syngas (62) can be contacted inside the at least one dehalogenation unit (52) in the same direction (co-current flow) or in opposite directions (counter-current flow). Preferably, the clinker raw mix (51) and the raw syngas (62) are contacted in a counter-current flow.

The portion of at least a portion of the hot air stream (59) not utilized as combustion air serves as a source of heat for a gasification reaction of a feedstock in at least one gasifier. In addition, at least a portion of the hot air stream is also used as an oxidant in said gasification reaction in case the at least one gasifier is selected from the group consisting of counter-current fixed bed reactors, co-current-fixed bed reactors, bubbling fluidized bed reactors, and circulation fluidized bed reactors. In addition, the pre-heated clinker raw mix (53) is utilized as a reactant for halogens in the raw syngas (62) and providing the required thermal energy for said dehalogenation. Thereby, an at least partially dehalogenated syngas (63) is obtained in an economic fashion.

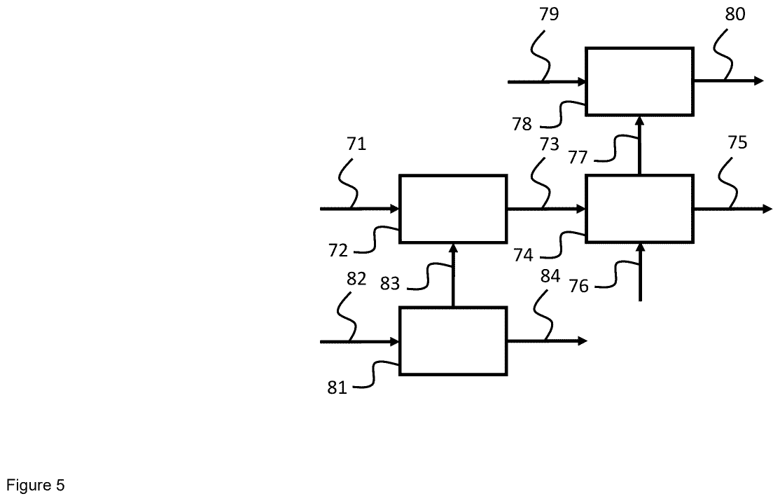

In a fourth embodiment of the present invention (FIG. 5), a pre-heated clinker raw mix (71) is entering the at least one cement kiln (72) in which the clinker raw mix (71) is converted by a thermochemical process into hot clinker (73) which leaves the at least one cement kiln in downstream direction. The at least one cement kiln (72) is heated by combustion of at least one fuel.

At least one clinker cooler (74) is downstream of and fluidically connected to the at least one cement kiln (72). The hot clinker (73) is entering the at least one clinker cooler (74) and is contacted with an air stream (76). Next, the cold clinker (75) leaves the at least one clinker cooler (74) in downstream direction and is further processed. Heat is transferred from the hot clinker (73) inside the at least one clinker cooler (74) to the air stream (76) which leaves the at least one clinker cooler (74) as a hot air stream (77).

The pre-heated clinker raw mix (71) has a temperature of about 750° C. to about 850° C. when entering the at least one cement kiln (72). The pre-heated clinker raw mix (71) moves through the at least one cement kiln (72) which is usually a rotary kiln at a temperature of about 1350° C. to about 1500° C. within about 20 min to about 40 min. The hot clinker (73) leaving the at least one cement kiln (72) has a temperature of about 1150° C. to about 1350° C. which is about the same temperature range of the hot clinker (73) when entering the at least one clinker cooler (74).

The clinker cooler (74) is preferably a grate cooler through which the hot clinker is transported horizontally, and an air stream (76) is for example blown from the bottom area of the at least one clinker cooler (74) through the hot clinker (73) and leaves the at least one clinker cooler (74) on the top section as a hot air stream (77) (=cross-countercurrent flow) or the air stream (76) is directed in a countercurrent flow scheme towards the moving hot clinker (73). The temperature of the hot air stream (77) ranges from about 700° C. to about 1100° C.

Next, at least a portion of the hot air stream (77) is used to provide heat for a gasification reaction in at least one gasifier (78). Accordingly, at least a portion of the hot air stream (77) is thermally coupled with the at least one gasifier (78). A first feedstock (79) enters the at least one gasifier (78) in which said first feedstock (79) is converted by a gasification reaction into raw syngas (80) which leaves the at least one gasifier (78) in downstream direction.

The type of thermal coupling of at least a portion of the hot air stream and the at least one gasifier depends on the type of gasifier used in the cement plant according to the present invention:
a) at least a portion of the hot air stream (77) can be inserted into the at least one gasifier (78) in case the at least one gasifier (78) is selected from the group consisting of counter-current fixed bed reactors, co-current-fixed bed reactors, bubbling fluidized bed reactors, and circulation fluidized bed reactors and wherein at least a portion of the hot air stream is inserted into said gasifier in a first aspect of the fourth embodiment. In this case at least a portion of the hot air stream (77) transfers heat to the at least one gasifier (78), i.e., is directly thermally coupled with the at least one gasifier (78) and in addition serves as the oxidant (which is a partial oxidation reaction which requires at least one oxidant) or
b1) the heat is transferred in a second aspect of the fourth embodiment (not shown in FIG. 5) from at least a portion of the hot air stream (77) to the at least one gasifier (78) in case the at least one gasifier is selected from the group consisting of downdraft entrained flow reactors and updraft entrained flow reactors by transferring heat from at least a portion of the hot air stream in the at least one means for heat transfer to a steam stream and/or an oxygen stream to form a pre-heated steam stream and/or a hot oxygen stream which serve(s) as oxidant in the gasification reaction and wherein at least a portion of the hot air stream and the at least one gasifier are indirectly thermally coupled by the steam stream and/or the oxygen stream or
b2) heat is transferred from at least a portion of the hot air stream (77) to the at least one gasifier (78) by a means for heat transfer (third aspect of the fourth embodiment, not shown in FIG. 5) in case the at least one gasifier is selected from the group consisting of downdraft entrained flow reactors and updraft entrained flow reactors wherein heat from at least a portion of the hot air stream is transferred then the means for heat transfer to a feedstock stream to form a pre-heated feedstock stream and wherein at least a portion of the hot air stream and the at least one gasifier are indirectly thermally coupled.

At least a portion of the hot air stream (77) can be inserted into the at least one gasifier (78) in case the at least one gasifier (78) is selected from the group consisting of counter-current fixed bed reactors, co-current-fixed bed reactors, bubbling fluidized bed reactors, and circulation fluidized bed reactors for example with at least one burner. Other suitable means for inserting a hot air stream into such gasifiers are known in the art and can be selected accordingly.

In the second aspect of the fourth embodiment of the present invention, the clinker raw mix (71) enters the at least one cement kiln (72) and the hot clinker (73) leaves the at least one cement kiln (72) in downstream direction. Next, the hot clinker (73) enters the clinker cooler (74) which is downstream of and fluidically connected to the at least one cement kiln (72). The hot clinker (73) is cooled by an air stream (76) in the clinker cooler (74). The cold clinker (75) leaves the clinker cooler (74) in downstream direction. The hot air stream (77) also leaves the clinker cooler (74) and is inserted into at least one means for heat transfer (not shown in FIG. 5) which is fluidically connected to the clinker cooler (74). A steam stream and/or an oxygen stream (not shown in FIG. 5) also enter(s) the at least one means for heat transfer. Heat is transferred from at least a portion of the hot air stream (77) to the steam stream and/or the oxygen stream inside the at least one means for heat transfer. A cold air stream (not shown in FIG. 5) and a pre-heated steam stream and/or a hot oxygen stream (not shown in FIG. 5) leave the at least one means for heat transfer through a cold air stream outlet and a pre-heated steam stream and/or a hot oxygen stream outlet, respectively. The pre-treated steam stream and/or the hot oxygen stream then enter(s) the at least one gasifier (78) which is downstream of and fluidically connected to the pre-heated steam stream outlet and/or the hot oxygen stream outlet. The preheated steam stream and/or the hot oxygen stream serve(s) as the oxidant for the gasification reaction inside the at least one gasifier (78). A first feedstock stream (79) enters the at least one gasifier (78) and is converted in a gasification reaction with the pre-heated steam stream and/or the hot oxygen stream to a raw syngas stream (80) which leaves the at least one gasifier (78) in downstream direction. The raw syngas stream (80) optionally comprises halogens.

The at least one gasifier (78) is preferably selected in this second aspect of the first invention from the group consisting of downdraft entrained flow reactors and updraft entrained flow reactors.

Preferably, the steam stream is heated in the at least one means for heat transfer by at least a portion of the hot air stream (77) before entering the at least one gasifier (78) as a pre-heated steam stream. More preferably, the oxygen stream is heated in the at least one means by heat transfer by at least a portion of the hot air stream (77) before entering the at least one gasifier (78) as a hot oxygen stream. Most preferably, heat is transferred from at least a portion of the hot air stream in a first means for heat transfer to a steam stream and then heat is transferred from at least a portion of the hot air stream in a second means for heat transfer to the oxygen stream.

The at least one means for heat transfer is preferably a heat exchanger suitable for transferring heat from a first gaseous stream to a second gaseous stream. The means for heat transfer is more preferably selected from the group comprising double-pipe heat exchangers, shell-and-tube heat exchangers, plate heat exchangers, plate fin heat exchangers, microchannel heat exchangers, and waste heat recovery units. Suitable flow arrangements comprise countercurrent flow, cross-current flow and the like.

In case heat is transferred from at least a portion of the hot air stream to the oxygen stream and the steam stream, heat is preferably transferred from at least a portion of the hot air stream to the steam stream in a first means for heat exchange and then heat is transferred from at least a portion of the hot air stream to the oxygen stream in a second means for heat transfer. More preferably, the first means for heat transfer is a heat exchanger suitable for transferring heat from a first gaseous stream to a second gaseous stream and the second means for heat transfer is a heat exchanger suitable for transferring heat from a first gaseous stream to a second gaseous stream. Most preferably, the first means for heat transfer is selected from the group comprising double-pipe heat exchangers, shell-and-tube heat exchangers, plate heat exchangers, plate fin heat exchangers, microchannel heat exchangers, and waste heat recovery units. Most preferably, the second means for heat transfer is selected from the group comprising double-pipe heat exchangers, shell-and-tube heat exchangers, plate heat exchangers, plate fin heat exchangers, microchannel heat exchangers, and waste heat recovery units. Suitable flow arrangements comprise for the first means for heat transfer and the second means for heat transfer counter-current flow, cross-current flow and the like.

In the third aspect of the fourth embodiment of the present invention, the clinker raw mix (71) enters the at least one cement kiln (72) and the hot clinker (73) leaves the at least one cement kiln (72) in downstream direction. Next, the hot clinker (73) enters the clinker cooler (74) which is downstream of and fluidically connected to the at least one cement kiln (72). The hot clinker (73) is cooled by an air stream (76) in the clinker cooler (74). The cold clinker (75) leaves the clinker cooler (74) in downstream direction. The hot air stream (77) also leaves the clinker cooler (74) and is inserted into a means for heat transfer (not shown in FIG. 5) which is fluidically connected to the clinker cooler (74). A first feedstock stream (not shown in FIG. 5) also enters the means for heat transfer. Heat is transferred from at least a portion of the hot air stream (77) to the first feedstock stream inside the means for heat transfer. A cold air stream and a preheated first feedstock stream leave the means for heat transfer through a cold air stream outlet and a pre-heated first feedstock stream outlet, respectively. The pre-heated first feedstock stream then enters the at least one gasifier (78) which is downstream of and fluidically connected to the pre-heated first feedstock stream outlet and is converted in a gasification reaction with an oxygen stream optionally together with a steam stream as oxidant to a raw syngas stream (80) which leaves the at least one gasifier (78) in downstream direction.

The at least one gasifier (78) is preferably selected in this third aspect of the fourth embodiment from the group consisting of downdraft entrained flow reactors and updraft entrained flow reactors.

The means for heat transfer is preferably a heat exchanger suitable for transferring heat from a gaseous stream (at least a portion of the hot air stream (77)) to a solid and/or liquid first feedstock stream. Suitable heat exchangers comprise direct contact heat exchangers, plate heat exchangers, tube heat exchangers and the like. Suitable heat exchangers for transferring heat from a gaseous stream (at least a portion of the hot air stream (77)) to a solid and/or liquid first feedstock are known in the art and can be selected accordingly. Suitable flow arrangements comprise counter-current flow, cross-current flow and the like.

The cement plant according to the first aspect of the fourth embodiment, the second aspect of the fourth embodiment, and the third embodiment of the fourth embodiment further comprises at least one pyrolysis reactor (81) having an inlet for a second feedstock (82), a first outlet for a condensable pyrolysis product stream (84) (“pyrolysis oil”), a second outlet for a non-condensable pyrolysis product stream (83) (“pyrolysis gas”), and a third outlet for the solid and highly viscous side products of a pyrolysis reaction (not shown in FIG. 5). The non-condensable pyrolysis stream (83) comprises methane, ethane, propane, H₂, and CO₂. The at least one cement kiln (72) is downstream of and fluidically connected to the second outlet for a non-condensable pyrolysis product stream (83). The non-condensable pyrolysis product stream (83) leaves the at least one pyrolysis reactor (81) through the second outlet for a non-condensable pyrolysis product stream (83), enters the at least one cement kiln (72) in which the non-condensable pyrolysis product stream (83) is utilized as a complementary fuel to heat the clinker inside the at least one cement kiln. The solid and highly viscous side products of a pyrolysis reaction can optionally also be used as a complementary fuel to heat the clinker inside the at least one cement kiln.

The second feedstock is preferably selected from mixed waste plastic and waste rubber such as end-of-life tires. Other feedstocks suitable for a pyrolysis reaction can also be used as secondary feedstock.

The pyrolysis reaction is a thermal decomposition or degradation of feedstocks such as mixed waste plastics and tires under inert conditions and results in a gaseous fraction, a liquid fraction, and a solid char fraction. During the pyrolysis, the feedstocks are converted into a great variety of chemicals including a) gases such a H₂, C₁-C₄-alkanes, C₂-C₄-alkenes, ethyne, propyne, 1-butyne, b) pyrolysis oil having a boiling temperature in the range of 25 to 500° C. and c) char. Pyrolysis processes as such are known. They are described, e.g., in EP 0713906 A1 and WO 95/03375 A1.

The gaseous fraction comprising methane, ethane, propane, H₂, and CO₂ can be used as a complementary fuel to heat the clinker inside the at least one cement kiln. Said gaseous fraction has a higher calorific value than other complementary (“secondary”) fuels such as waste. The liquid fraction i.e., the pyrolysis oil having a boiling temperature in the range of 25 to 500° C., can be for example used as a feedstock for a steam cracker to produce olefins and/or a syngas plant to produce syngas. The pyrolysis oil can be transported in suitable vessels by e.g., truck or rail to another location for further processing. The solid and highly viscous side products of a pyrolysis reaction can also be used as a complementary fuel to heat the clinker inside the at least one cement kiln.

Accordingly, the cement plant further comprises at least one pyrolysis reactor which produces pyrolysis oil and pyrolysis gas from a second feedstock and wherein said pyrolysis gas is used to heat the at least one cement kiln.

The portion of the hot air stream (77) not utilized as combustion air serves as a source of heat for a gasification reaction of a first feedstock in at least one gasifier. In addition, at least a portion of the hot air stream is also used as an oxidant in said gasification reaction in case the at least one gasifier is selected from the group consisting of counter-current fixed bed reactors, cocurrent-fixed bed reactors, bubbling fluidized bed reactors, and circulation fluidized bed reactors or at least a portion of the hot air stream is used to transfer heat to a steam stream and/or to an oxygen stream to form a pre-heated steam stream and/or a hot oxygen stream which is/are then fed into the at least one gasifier or at least a portion of the hot air stream is used to transfer heat to a first feedstock which is then fed into the at least one gasifier. In addition, the non-condensable pyrolysis product stream (83) is utilized as a complementary fuel to heat the clinker inside the at least one cement kiln.

Any combinations of the first, the second, the third, and the fourth embodiment of the present invention as described above are withing the scope of the invention.

For example, the components of a cement plant according to the first embodiment can be combined with a dehalogenation unit (third embodiment) and a pyrolysis reactor (fourth embodiment), and so on.

The hot clinker leaves the cement kiln after passing through a pre-cooling zone at a temperature of about 1150° C. to about 1350° C. The hot clinker then enters a clinker cooler in which it is cooled down to about 80° C. to about 200° C. using an air stream. Suitable clinker cooler designs comprise tube cooler, planetary cooler, satellite cooler, and grate cooler. The hot clinker is cooled in the at least one clinker cooler with an air stream in countercurrent or cross-countercurrent flow. The hot parts of such clinker coolers are equipped with refractory materials. The hot clinker is contacted with the air stream inside the clinker cooler. Heat from the hot clinker is transferred to the air stream which leaves the clinker cooler as a hot air stream.

Most preferably, the at least one clinker cooler is a grate cooler. The hot clinker is transported on a moving or on a combination of stationary and moving grates in such grate coolers. Grate coolers are suited for a higher throughput of hot clinker and the option to split the stream of hot air formed inside the clinker cooler during heat transfer from the hot clinker to the air stream for further utilization. Grate coolers require more cooling air than is necessary for combustion (i.e., as secondary combustion air and, optionally, as tertiary combustion air).

The first feedstock is preferably a solid and/or liquid material or mixture of materials which comprises organic compounds and/or organic polymers. Said organic compounds and/or organic polymers contain biogenic carbon and/or carbon of fossil sources. The carbon is preferably from post-consumer waste (“recycle content carbon”). The first feedstock may further contain impurities such as inorganic components and metallic components. Preferably, the first feedstock is a solid and/or liquid feedstock and is selected from the group comprising carbonaceous products from crude oil refining such as extra heavy crude oil, tar sand, bitumen, coke, biomass, waste, mixtures thereof, and mixtures thereof with fossil feedstocks such as coal, oil, and natural gas.

The term “biomass” includes but is not limited to wood, wood pellets, wood chips, straw, lignocellulosic biomass, energy crops, and algae.

The term “waste” comprises fossil-based waste, biobased waste, and mixtures thereof. Examples for waste suitable as a feedstock are agricultural/farming residues such as wood processing residues, waste wood, logging residues, switch grass, discarded seed corn, corn stover and other crop residues, municipal solid waste (MSW), textiles, industrial waste, sewage sludge, plastic waste, mixed plastic waste, end-of-life tyres, packaging waste, shredder residues such as car shredder residues and mixtures thereof.

Preferably, the feedstock is selected from the group comprising biomass, municipal solid waste (MSW), shredder residues such as car shredder residues, textiles, plastic waste, packaging waste, and mixtures thereof.

The selection of gasifier type and gasifier size depends on physical and/or chemical properties of the feedstock, the physical and/or chemical properties preferably selected from the group comprising water content, ash content, elemental composition, particle size distribution, and calorific value. Furthermore, the selection of gasifier type and gasifier size also depends on the availability of feedstock types and amounts and the infrastructure for transporting feedstock to the location where the at least one gasifier is installed. The selection of gasifier type and gasifier size also depends on the pre-treatment method applied to the feedstock. An overview of gasifier types is for example provided in James G. Speight, Handbook of Gasification Technology, Scrivener Publishing and Wiley, 2020, chapter 8.4.2, pages 259 to 262.

The at least one gasifier is selected from the group comprising counter-current fixed bed reactors, co-current-fixed bed reactors, bubbling fluidized bed reactors, circulation fluidized bed reactors, downdraft entrained flow reactors, and updraft entrained flow reactors.

In case the cement plant according to the present invention contains two or more gasifiers, the at least two gasifiers are selected from the group comprising counter-current fixed bed reactors, co-current-fixed bed reactors, bubbling fluidized bed reactors, circulation fluidized bed reactors, downdraft entrained flow reactors, and updraft entrained flow reactors and are preferably installed in a serial manner, i.e., gasifier 2 is downstream of and fluidically connected to gasifier 1. The advantage of at least two gasifiers installed in this fashion is a higher conversion of the feedstock and intermediate products of the gasification reaction into the desired syngas components H₂ and CO. More preferably, the first gasifier and the second gasifier are preferably different types of gasifiers. Most preferably, the first gasifier (gasifier 1) is selected from the group consisting of counter-current fixed bed reactors, co-current-fixed bed reactors, bubbling fluidized bed reactors, circulation fluidized bed reactors and the second gasifier (gasifier 2) is a downdraft entrained flow reactors or an updraft entrained flow reactor. In this case, conversion of the feedstock and intermediate products of the gasification reaction into the desired syngas components H₂ and CO is even higher. Furthermore, in this preferred installation, the solid side products such as sludge are preferably free of carbon and can therefore be disposed in e.g., landfills without further treatment. The same restrictions in respect to hot air or hot oxygen inserted into the at least one gasifier as discussed above apply also to this aspect of the present invention.

In case three gasifiers are connected to each other in this fashion, all three gasifiers are preferably different types of gasifiers. The advantage such an installation, especially when different types of gasifiers are employed, is an even higher yield of the desired syngas components H₂ and CO.

The at least one gasifier is preferably selected from the group consisting of counter-current fixed bed reactors, co-current-fixed bed reactors, bubbling fluidized bed reactors, and circulation fluidized bed reactors and wherein at least a portion of the hot air stream is inserted into said at least one gasifier or wherein said at least one gasifier is preferably selected from the group consisting of downdraft entrained flow reactors and updraft entrained flow reactors and wherein the cement plant further comprises a means for transferring heat from at least a portion of the hot air stream to an oxygen stream and/or to a steam stream.

The gasification reaction in a gasifier is typically carried out at a temperature >500° C. in the presence of a sub-stoichiometric amount of an oxidant such as oxygen, air, steam, supercritical water, or a mixture of the aforementioned. Oxygen is the most common oxidant used for gasification because of its easy availability and low cost. If steam acts as oxidant, the raw syngas has a higher first molar ratio H₂:CO than in case if oxygen is used as oxidant. For example, a typical molar ratio “air:oxygen required for a total oxidation of the feedstock” ranges from 0.3 to <1.

The conversion of a feedstock in the at least one gasifier results in a raw syngas which consists primarily of H₂, CO, H₂O, CO₂, methane, other hydrocarbons, and impurities. Said raw syngas has a first molar ratio H₂:CO when leaving the gasifier which ranges from about 0.1:1 to about 3:1 and depends on the type of solid and/or liquid feedstock used, the oxidant and other reaction conditions applied such as temperature and/or residence time for the gasification reaction. The most desired components of syngas are H₂ and CO.

The following optional features of the present invention can be combined with any of the embodiments described before:

Optionally, the raw syngas obtained by gasification in the at least one gasifier is purified in at least one syngas purification unit to obtain a clean syngas. Other gaseous substances such as HCl and H₂S are formed and/or separated from the raw syngas in the optional at least one syngas purification unit. Impurities are removed from the raw syngas in the at least one syngas purification unit and a clean syngas is produced from the raw syngas.

The use of a clean syngas obtained from the optional at least one syngas purification unit is preferred because catalysts utilized in successive process steps have an improved lifetime and maintain their activity when using a clean syngas instead of the raw syngas obtained directly from the gasification reaction in the at least one gasifier.

Typical impurities in the raw syngas obtained from the gasification reaction in at least one gasifier comprise chlorides, sulfur-containing organic compounds such as sulfur dioxide, trace heavy metals (e.g., as respective salts) and particulate residues. Various chemical and/or physical methods for removal of such impurities from said raw syngas such as filtration, scrubbing, hydrotreatment and ab-/adsorption are known and can be chosen and adapted according to the type and respective concentration of the impurities in said raw syngas and the tolerance to such impurities in the successive process steps. Some selected methods for removal of impurities from said raw syngas will be discussed in more detail. One or more of said methods can also be implemented into the optional at least one syngas purification unit. The selection of such methods is not limiting the scope of the present invention. A portion of said impurities is removed from the syngas together with the ash and/or sludge formed as a side product in the gasification reaction.

Fine particles can be removed from the raw syngas by a cyclone and/or filters; trace heavy metals, and chlorides by wet scrubbing, catalytic hydrolysis for converting sulfur-containing organic compounds to H₂S and acid gas removal for extracting sulfur-containing gases such as H₂S. Bulky and fine particles in the syngas may also be removed with a quench in a soot water washing unit.

Preferably, the cement plant further comprises a syngas purification unit for producing a clean syngas from the raw syngas, said syngas purification unit downstream and fluidically connected to the at least one gasifier.

Optionally, the cement plant comprises a further chemical synthesis unit selected from the group comprising methanation unit, methanol synthesis unit, and Fischer-Tropsch synthesis unit, said further chemical synthesis unit downstream of and fluidically connected to the syngas purification unit or to an optional water-gas shift unit, said optional water-gas shift unit downstream of and fluidically connected to said syngas purification unit and upstream and fluidically connected to said optional chemical synthesis unit.

The clean syngas may be subjected to a water-gas shift reaction prior to feeding it into the optional methanation unit or methanol unit or Fischer-Tropsch unit. The water-gas shift reaction can be combined with the gasification in the at least one gasifier and/or the water-gas shift reaction is performed in a separate water-gas-shift unit which is downstream of and fluidically connected to the at least one syngas purification unit.

The impurities are removed from the raw syngas and the clean syngas having a first molar ratio H₂:CO then optionally enters a methanation unit (preferably with a water gas-shift unit downstream of and fluidically connected to the at least one syngas purification unit and upstream of and fluidically connected to the methanation unit) or a methanol synthesis unit (preferably with a water gas-shift unit downstream of and fluidically connected to the at least one syngas purification unit and upstream of and fluidically connected to the methanol synthesis unit) or a Fischer-Tropsch synthesis unit (preferably with a water gas-shift unit downstream of and fluidically connected to the at least one syngas purification unit and upstream of and fluidically connected to the Fischer-Tropsch synthesis unit) where the clean syngas is converted into methane or methanol or Fischer-Tropsch hydrocarbons.

Methane is formed by a methanation reaction in a methanation unit. The optional methanation unit is downstream of and fluidically connected to the at least one gasifier and/or the at least one optional syngas purification unit or the optional methanation unit is downstream of and fluidically connected to a water-gas shift unit.

In this case, the clean syngas having a first molar ratio H₂:CO is preferably subjected to a water-gas shift reaction in the at least one water-gas shift unit. Thereby, the H₂ content in the clean syngas is increased by reacting a portion of the CO of the clean syngas with water to form additional H₂ (and CO₂) and thereby the second syngas having a second molar ratio H₂:CO is formed and leaves the at least one water-gas shift unit. The H₂ content in said second syngas having a second molar ratio H₂:CO is higher than in said clean syngas having a first molar ratio H₂:CO. This step is known as water-gas shift reaction and represented by the chemical reaction scheme (1):

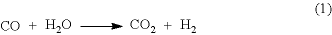

The water-gas shift reaction will operate with a variety of catalysts (such as copper-zinc-aluminum catalysts and chromium or copper promoted iron-based catalysts) in the temperature range between about 200° C. and about 480° C. The type of water-gas shift reaction und unit(s) required can be adapted to the general conditions of the process (e.g., type of feedstock for the gasification reaction used and how much additional H₂ obtained by chemical reaction scheme (1) is desired).

The methanation reaction is described by chemical reaction schemes (2) and (3):

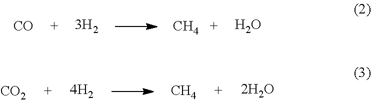

The methanation reaction and suitable methanation units are for example described in S. Rönsch, J. Schneider, S. Matthischke, M. Schlüter, M. Götz, J. Lefebvre, P. Prabhakaran, S. Bajohr: Review on methanation—From fundamentals to current projects; Fuel 166 (2016) 276-296 and can be selected and adapted by the skilled person.

The methanation reaction is for example a catalytic reaction using nickel on alumina catalysts, preferably a honeycomb shape catalyst, at 1 bar to 70 bar and 200° C. to 700° C., preferably 5 bar to 60 bar and 200 to 700° C., more preferably 10 bar to 45 bar and 200° C. to 550° C.

The clean syngas can be converted into methanol in an optional methanol synthesis unit. In this case, the clean syngas having a first molar ratio H₂:CO is preferably subjected to a water-gas shift reaction in the at least one water-gas shift unit as described above before entering the methanol synthesis unit. Methanol is produced from syngas by a catalytic gas phase reaction at about 5 MPa to about 10 MPa and about 200° C. to about 300° C. using a catalyst in a low-pressure methanol process in e.g., adiabatic reactors or quasi-isothermal reactors. The clean syngas is provided by the syngas purification unit or by an optional water-gas shift unit in which the molar ratio H₂:CO is modified for the methanol synthesis. The catalyst is for example a mixture of copper and zinc oxides, supported on alumina. The methanol synthesis and various options thereof suitable to be combined with the production system according to the present invention are disclosed in Ullmann's Encyclopedia of Industrial Chemistry (2012), Chapter “Methanol”, p. 3 to 12.

The clean syngas can be converted into hydrocarbons (“Fischer-Tropsch hydrocarbons”) such as light synthetic crude oil in an optional Fischer-Tropsch (FT) reaction unit by the FT process. In this case, the clean syngas having a first molar ratio H₂:CO is preferably subjected to a water-gas shift reaction in the at least one water-gas shift unit as described above before entering the FT synthesis unit. The light synthetic oil can be further converted by hydrocracking and/or isomerization to naphtha, light olefins, or diesel fuel. For production of gasoline and light olefins, the FT process is operated in a temperature range of about 330° C. to about 350° C. and a pressure of about 2.5 MPa (high-temperature FT-process), for production of waxes and/or diesel fuel, in a temperature range of about 220° C. to about 250° C. and a pressure of about 2.5 MPa to about 4.4 MPa (low-temperature FT-process). Suitable reactors for low-temperature FT-processes comprise tubular fixed-bed reactors and slurry bed reactors. Suitable reactors for high-temperature FT-processes comprise circulating fluidized-bed reactors and SAS (Sasol advanced synthol) reactors. Iron- and/or cobalt-based catalysts are used for the FT-process. The Fischer-Tropsch synthesis and various options thereof suitable to be combined with the production system according to the present invention are disclosed in Ullmann's Encyclopedia of Industrial Chemistry (2012), Chapter “Coal Liquefaction”, p. 20 to 33.

Accordingly, the cement plant optionally further comprise a syngas purification unit for obtaining a clean syngas, said syngas purification unit downstream and fluidically connected to the gasifier and, optionally, a methanation unit for obtaining methane from the clean syngas, said optional methanation unit downstream of and fluidically connected to the syngas purification unit or to an optional water-gas shift unit, said optional water-gas shift unit downstream of and fluidically connected to said syngas purification.

The advantage of the optional conversion of the syngas into methane is as follows: A cement plant and method according to the present invention where and with which syngas is produced is usually installed in a different location than (petro-) chemical plant(s) which require syngas as a feedstock to produce chemical products. Furthermore, the transportation of syngas over longer distances is not feasible because of safety considerations. The conversion of syngas produced by gasification and successive transformation of syngas into methane, said methane is suited for transportation in a natural gas pipeline grid to the location wherein syngas is required as a feedstock. The methane is there converted by e.g., methane steam reforming back into syngas.

The raw syngas obtained by said method is optionally at least partially dehalogenated by contacting said raw syngas with pre-heated raw clinker mix.

The first feedstock is thermally pre-treated with at least a portion of the hot air stream, the thermal pre-treating selected from the group comprising drying and torrefaction.

Suitable drying methods comprise contacting at least a portion of the hot air stream with the first feedstock by belt drying, fluidized bed drying, drum drying, spray drying, hearth drying, and rotary tray drying.

At least a portion of the hot air stream can be used to indirectly heat a first feedstock, preferably biomass, in a torrefaction pre-treatment to a temperature in the range of about 200° C. to about 320° C. to convert the first stock into char and thereby obtain a first feedstock having a better fuel quality for the gasification reaction.

Optionally, the raw syngas is cleaned in an optional syngas purification unit and the cleaned syngas is then converted into a chemical product selected from the group comprising methane, methanol, and Fischer-Tropsch hydrocarbons, optionally after a water-gas shift reaction of the cleaned syngas.

Optionally, a portion of the raw syngas is used to heat a cement kiln by combustion of said raw syngas in said method.

1.-15. (canceled)

16. A cement plant comprising
(i) at least one cement kiln which is heated by combustion of at least one fuel and in which hot clinker is formed from a pre-heated raw clinker,
(ii) at least one clinker cooler in which said hot clinker transfers heat to an air stream to form a hot air stream,
wherein said clinker cooler is downstream of and fluidically connected to said at least one cement kiln,
(iii) and at least one gasifier for producing raw syngas from a first feedstock by gasification, said raw syngas optionally comprising halogens,
wherein at least a portion of the hot air stream formed in step (ii) and said at least one gasifier are directly or indirectly thermally coupled.

17. The cement plant according to claim 16, wherein said at least one gasifier is selected from the group consisting of counter-current fixed bed reactors, co-current-fixed bed reactors, bubbling fluidized bed reactors, and circulation fluidized bed reactors, and wherein at least a portion of the hot air stream is inserted into said at least one gasifier, and wherein at least a portion of the hot air stream and the at least one gasifier are directly thermally coupled or wherein said at least one gasifier is selected from the group consisting of downdraft entrained flow reactors and updraft entrained flow reactors and wherein the cement plant further comprises at least one means for transferring heat from at least a portion of the hot air stream to a steam stream or to an oxygen stream to form a pre-heated steam stream or a hot oxygen stream and wherein at least a portion of the hot air stream and the at least one gasifier are indirectly thermally coupled or
wherein said at least one gasifier is selected from the group consisting of downdraft entrained flow reactors and updraft entrained flow reactors and wherein the cement plant further comprises a means for transferring heat from at least a portion of the hot air stream to a first feedstock stream to form a pre-heated first feedstock stream and wherein at least a portion of the hot air stream and the at least one gasifier are indirectly thermally coupled.

18. The cement plant according to claim 16, wherein the temperature of the hot air stream formed in step (ii) ranges from about 700° C. to about 1100° C.

19. The cement plant according to claim 16, wherein at least a portion of the raw syngas formed in the gasifier is used as a fuel to heat the at least one cement kiln by combustion of said fuel.

20. The cement plant according to claim 16, wherein the raw syngas further comprises halogens, wherein the cement plant further comprises a means for pre-heating the raw clinker mix and a means for contacting said pre-heated raw clinker mix with said raw syngas whereby at least a portion of said halogens are transferred from said raw syngas to said pre-treated clinker, and wherein said means for contacting said pre-heated raw clinker mix with said raw syngas has an entrance for pre-treated raw clinker mix and an exit for pre-heated raw clinker mix, and wherein said entrance for pre-heated raw clinker mix is downstream of and fluidically connected to said means for pre-heating the raw clinker mix, and wherein said at least one cement kiln is downstream of and fluidically connected to said exit for pre-heated raw clinker mix.

21. The cement plant according to claim 16, wherein said cement plant further comprises at least one pyrolysis reactor which produces pyrolysis oil and pyrolysis gas from a second feedstock, and wherein said pyrolysis gas is used to heat the at least one cement kiln.

22. The cement plant according to claim 16, wherein the at least one clinker cooler is a grate cooler.

23. The cement plant according to claim 20, wherein said pre-heated raw clinker and said raw syngas are contacted in a countercurrent flow.

24. The cement plant according to claim 16, wherein the cement plant further comprises a syngas purification unit for producing a clean syngas from the raw syngas, said syngas purification unit downstream and fluidically connected to the at least one gasifier and, optionally, a further chemical synthesis unit selected from the group comprising methanation unit, methanol synthesis unit, and Fischer-Tropsch synthesis unit, said further chemical synthesis unit downstream of and fluidically connected to the syngas purification unit or to an optional water-gas shift unit, said optional water-gas shift unit downstream of and fluidically connected to said syngas purification unit and upstream and fluidically connected to said optional chemical synthesis unit.

25. A method for gasification of a first feedstock in at least one gasifier, comprising the steps
(i) providing a cement plant comprising at least one cement kiln, at least one clinker cooler and at least one gasifier,
(ii) forming hot clinker in the at least one cement kiln,
(iii) cooling the hot clinker in at least one clinker cooler with an air stream and thereby forming a hot air stream,
(iv) transferring heat from at least a portion of the hot air stream to the at least one gasifier, and
(v) forming raw syngas in the at least one gasifier, said raw syngas optionally comprising halogens.

26. The method according to claim 25, wherein in step (iv)
a) at least a portion of the hot air leaving the at least one clinker cooler is inserted into at least one gasifier or
b1) thermal energy is transferred from at least a portion of the hot air leaving the at least one clinker cooler to a steam stream or an oxygen stream, which steam stream or oxygen stream is then fed into at least one gasifier or
b2) thermal energy is transferred from at least a portion of the hot air leaving the at least one clinker cooler to a first feedstock, which first feedstock is then fed into at least one gasifier.

27. The method according to claim 25, wherein the at least one gasifier is selected from the group consisting of
a) counter-current fixed bed reactors, co-current-fixed bed reactors, bubbling fluidized bed reactors, and circulation fluidized bed reactors, and wherein at least a portion of the hot air stream is inserted into said at least one gasifier, and wherein at least a portion of the hot air stream and the at least one gasifier are directly thermally coupled or
b1) wherein said at least one gasifier is selected from the group consisting of downdraft entrained flow reactors and updraft entrained flow reactors and wherein the cement plant further comprises at least one means for transferring heat from at least a portion of the hot air stream to a steam stream or to an oxygen stream to form a pre-heated steam stream or a hot oxygen stream and wherein at least a portion of the hot air stream and the at least one gasifier are indirectly thermally coupled or
b2) wherein said at least one gasifier is selected from the group consisting of downdraft entrained flow reactors and updraft entrained flow reactors and wherein the cement plant further comprises a means for transferring heat from at least a portion of the hot air stream to a first feedstock stream to form a pre-heated first feedstock stream and wherein at least a portion of the hot air stream and the at least one gasifier are indirectly thermally coupled.

28. The method according to claim 25, wherein the temperature of the hot air stream formed in step (ii) ranges from about 700° C. to about 1100° C.

29. The method according to claim 25, wherein the raw syngas is at least partially dehalogenated by contacting the raw syngas with the pre-heated raw clinker mix.

30. The method according to claim 25, wherein the raw syngas is cleaned in an optional syngas purification unit and the cleaned syngas is then converted into a chemical product selected from the group comprising methane, methanol, and Fischer-Tropsch hydrocarbons, optionally after a water-gas shift reaction of the cleaned syngas.
